(19) United States
(12) Patent Application Publication
(10) Pub. No.: US 2008/0288576 A1
(43) Pub. Date: Nov. 20, 2008

(54) Method and System for Sharing One or More Graphics Images Between Devices Using Profiles

(75) Inventors: Michael Pierre Carlson, Austin, TX (US); Linda Arnold Lisle, Cedar Park, TX (US); Herman Rodriguez, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(73) Assignee: INTERNATIONAL BUSINESS MACHINES CORPORATION, Armonk, NY (US)

(21) Appl. No.: 12/055,197

(22) Filed: Mar. 25, 2008

Related U.S. Application Data
(63) Continuation of application No. 11/008,816, filed on Dec. 9, 2004.

(51) Int. Cl. G06F 15/16

(52) U.S. Cl. 709/202

(57) ABSTRACT

The present invention provides a method and system for sharing one or more graphics images between devices using profiles. A request to establish a communications link is transmitted from a first device to a second device using a first profile. A response indicating acceptance of the first profile or a request to negotiate a different profile is received from the second device. A profile matching the second device is negotiated and selected at the first device. One or more graphics images are transmitted from the first device to the second device using the profile matching the second device.

### CROSS REFERENCE TO RELATED APPLICATIONS

The present application is a continuation of U.S. application Ser. No. 11/008,816 filed Dec. 9, 2004. Said U.S. application Ser. No. 11/008,816 is hereby incorporated by reference in its entirety.

### FIELD OF THE INVENTION

The present invention generally relates to the field of telecommunication, particularly to a method and system for sharing one or more graphics images between devices using profiles.

### BACKGROUND OF THE INVENTION

Conventional PDAs (Personal Digital Assistants) and mobile phones provide a built-in camera for capturing one or more graphics images, which may be viewed in real-time or sent to another user. It is understood that a single graphics image may be a photograph or drawing while multiple graphics images may represent a movie or animation (with or without sound). Some of these PDAs and mobile phones have a built-in flash that may be used in low light conditions. Although conventional PDAs and mobile phones are viewed as a convenience, the captured one or more graphics images cannot be used by others until it has been uploaded to a server and downloaded to other users.

One technique that has been employed to share one or more graphics images among several users is to multicast the content. This technique works fine where data encryption is not necessary. However, when data confidentiality is needed, a high performance network and processing power is required to encrypt the transmitted data at the source, and to decrypt it at the receiver.

Thus, it is desirable to have a method and system for sharing one or more graphics images in real time with other users in a network, which method and system may provide data privacy without incurring the cost and rigor of encryption technologies.

### SUMMARY OF THE INVENTION

In an exemplary aspect of the present invention, a method for sharing one or more graphics images between devices includes steps as follows. A request to establish a communications link is transmitted from a first device to a second device using a first profile. A response indicating acceptance of the first profile or a request to negotiate a different profile is received from the second device. A profile matching the second device is negotiated and selected at the first device. One or more graphics images are transmitted from the first device to the second device using the profile matching the second device.

In an additional exemplary aspect of the present invention, a method for sharing one or more graphics images among devices includes steps as follows. A request to establish a communications link is transmitted from a first device to a second device and a third device using a first profile. Responses indicating acceptance of the first profile or requests to negotiate a different profile are received from the second device and the third device. A profile matching the second device and the third device is negotiated and selected at the first device. One or more graphics images are transmitted from the first device to the second device and the third device using the profile matching the second device and the third device.

In another exemplary aspect of the present invention, a system for sharing one or more graphics images between devices using profiles includes a first device and a second device. The first device is suitable for transmitting one or more graphics images using profiles. The profiles include at least one of a low bandwidth streaming video profile, a screen sharing profile, and a rights management profile. The second device is communicatively coupled to the first device via, for example, wire, wireless communication (e.g., Bluetooth, WiFi), and the like. The second device is suitable for receiving the one or more graphics images.

In a further exemplary aspect of the present invention, a system for sharing one or more graphics images among devices using profiles includes a first device, a second device and a third device. The first device is suitable for transmitting one or more graphics images using profiles. The profiles include at least one of a low bandwidth streaming video profile, a screen sharing profile, or a rights management profile. The second device is communicatively coupled to the first device via, e.g., wire, wireless communication (e.g., Bluetooth, WiFi), and the like. The second device is suitable for receiving the one or more graphics images. The third device is communicatively coupled to the first device via, for example, wire, wireless communication (e.g., Bluetooth, WiFi), and the like. The third device is suitable for receiving the one or more graphics images.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic diagram illustrating a system for sharing one or more graphics images between devices using a low bandwidth streaming video profile in accordance with an exemplary embodiment of the present invention;

FIG. 1A is a schematic diagram illustrating that receiving devices receive one or more graphics images with their individual bandwidth in accordance with an exemplary embodiment of the present invention;

FIG. 2 is a schematic diagram illustrating a system for sharing one or more graphics images between devices using a screen sharing profile in accordance with an exemplary embodiment of the present invention;

FIG. 3 is a schematic diagram illustrating a system for sharing one or more graphics images between devices using a rights management profile in accordance with an exemplary embodiment of the present invention; and

FIG. 4 is a flowchart of a method for sharing one or more graphics images between devices using at least one of a low bandwidth streaming video profile, a screen sharing profile, or a rights management profile in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

The present invention provides a method and system for sharing one or more graphics images captured by and/or stored in a camera with people (and devices) by creating new networking profiles such as for the existing Bluetooth protocol. For illustrative purposes, the present invention is described within the context of Bluetooth communications, although it is noted that any other networking protocol (e.g., WiFi, IrDA, etc.) can be used in alternative embodiments without departing from the scope and spirit of this invention.

Bluetooth is an industrial specification for wireless personal area networks (PANs). Bluetooth provides a way to connect and exchange information between devices such as PDAs, mobile phones, laptops, PCs, printers and digital cameras via a secure, low-cost, globally available short range radio frequency. Bluetooth enables these devices communicate with each other when they come in range, even if they are not in the same room, as long as they are with a certain range (e.g., 10 meters) of each other.

In order to use Bluetooth, a Bluetooth device must be able to interpret certain Bluetooth profiles. The Bluetooth profiles describe how the Bluetooth technology is used (i.e., how different parts of the specification can be used to fulfill a desired function for a Bluetooth device). A profile may be described as a vertical slice through the protocol stack. It defines options in each protocol that are mandatory for the profile. It also defines parameter ranges for each protocol. The profile concept is used to decrease the risk of interoperability problems between different manufacturers' products. These profiles do not (normally) define any additions to the Bluetooth specification, which is why new profiles can be added where desired. The underlying Bluetooth technology is the same, only the specific way that it is used is defined and clarified.

The following is a partial list of existing Bluetooth profiles:
Generic Access Profile (GAP) for discovering and accessing Bluetooth devices;
Serial Port Profile (SPP) to emulate serial port operation;
Generic Object Exchange Profile (GOEP) to set a path to a particular directory and create, delete, or move data objects;
Synchronization Profile (SP) to synchronize personal data such as phone books, calendar, etc.;
Object Push Profile (OPP) to push standard objects such as business cards (vCards), or a vCal object;
File Transfer Profile (FTP) to create, delete, and move file objects among users; and
Telephony Control Protocol Specification Profile to send audio calls between Bluetooth devices.

The following are some proposed Bluetooth profiles:
Car profile
Printing profile
Personal area network profile
Audio Visual Profile

The present invention adds the following new profiles to the existing Bluetooth protocol:
low bandwidth streaming video profile—this profile allows for sending streaming graphics images by interlacing the content over a discrete time period, using the lowest common transmission properties (hereinafter called the “lowest common denominator”) among cooperating devices to determine a size of a basic frame (e.g., a whole frame, or half a frame if interlaced, or a fraction of a frame) depending on the buffering capability of the sending and recipient nodes;
screen sharing profile—this profile allows for sharing a screen among users. Screen one or more graphics images data and input device actions may be shared among the paired users; and
rights management profile—this profile allows for securely administering digital rights management (DRM) between paired users by encrypting a rights management security string with the sender's private key and publishing the public key with paired users via a SOAP (Simple Object Access Protocol) message protocol.

Captured graphics images may be streamed using above profiles. Other users in the same area with compatible equipment and authorization may receive and view the graphics images.

Thus, with the present invention, a Bluetooth device (e.g., a mobile phone, a PDA, a laptop computer, a conference room projector, or the like) with a built-in camera as well as Bluetooth connectivity is able to capture and stream graphics images content over the Bluetooth network. Users located within a range of the Bluetooth transmission and with appropriate access authority are able to view the graphics images on their own Bluetooth devices (PDAs, mobile phones, laptops, or the like). This is especially useful in meetings where a single item needs being viewed by multiple parties. For example, at an IBM symposium meeting named IEB, participants may use the IBM IEB public key to access a presentation using the present invention.

Thus, according to the present invention, a phone/PDA with a built-in camera is enhanced with software to process the graphics image and transmit it over an appropriate network (e.g. Bluetooth). A menu option may allow the user to send the graphics image over the network. A separate device may be able to access the connection and access the graphics image being distributed on the network. Additional enhancements to the graphics image may be made by the other receiving devices.

It is understood that the present invention applies not only to Bluetooth devices, but also applies to other devices as contemplated by a person of ordinary skill in the art without departing from the scope and spirit of the present invention.

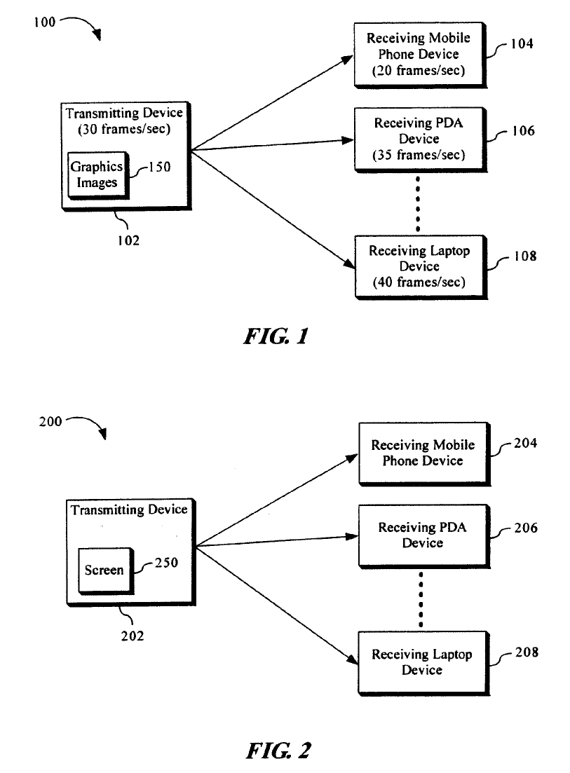

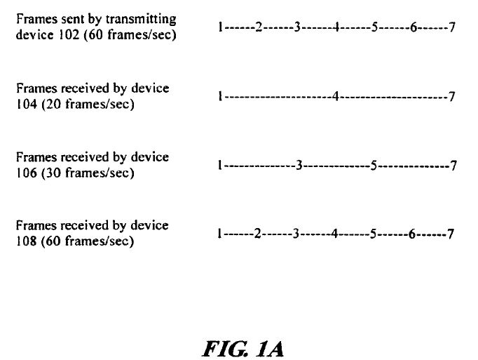

Referring now to FIG. 1, a system 100 for sharing one or more graphics images 150 between devices using a low bandwidth streaming video profile in accordance with an exemplary embodiment of the present invention is shown. The system 100 may include a transmitting device 102 for transmitting the one or more graphics images 150 using the low bandwidth streaming video profile. The one or more graphics images 150 may be captured by or may be stored in the transmitting device 102. The system 100 may include one or more receiving devices. For example, as shown in FIG. 1, the system 100 includes a receiving mobile phone device 104, a receiving PDA device 106, and a receiving laptop device 108. Each of the receiving devices is communicatively coupled to the transmitting device 102 via, e.g., wire, wireless communication (e.g., Bluetooth), and the like. Each of the receiving devices is suitable for receiving the one or more graphics images 150. The transmitting device 102 may be capable of transmitting the one or more graphics images 150 in a certain bandwidth. Each of the receiving devices may be capable of receiving the one or more graphics images 150 in its own bandwidth. In a first embodiment of the low bandwidth streaming video profile, a lower (or lowest) common denominator of processing and buffering capacity between the transmitting device and the receiving device (or devices) is used to determine a size of a basic bandwidth for the video 150. A negotiation phase between the participants of the graphics image session may take place. A roll-call to each of the participants is made prior to determining the frame rate. The roll-call is made using the current art discovery mechanism. Once all the participants have been polled to determine the frame-rate bandwidth, a calculation is made responsive to the reported capabilities of the participants. The bandwidth calculation assumes that the frame-rate will be the same for all participants. In this embodiment, a lowest common denominator bandwidth value is calculated so that at least all the participants can receive a common throughput. Each participant reports its graphics image capability (during the discovery phase) in order to calculate the lowest common denominator. As shown in FIG. 1, for example, the transmitting device 102 is capable of transmitting the one or more graphics images 150 in a bandwidth of 30 frames/second, the receiving mobile phone device 104 may be capable of receiving the one or more graphics images 150 in a bandwidth of 20 frames/second, the receiving PDA device 106 may be capable of receiving the video 150 in a bandwidth of 35 frames/second, and the receiving laptop device 108 may be capable of receiving the one or more graphics images 150 in a bandwidth of 40 frames/second. Thus, the lowest common bandwidth is 20 frames/second. According to this embodiment, the transmitting device 102 may transmit the one or more graphics images 150 in a bandwidth of 20 frames/second so that all receiving devices may receive the one or more graphics images 150 without losing frames.

In an alternative embodiment of the low bandwidth streaming video profile, the transmitting device 102 may be suitable for transmitting the one or more graphics images 150 with a first bandwidth, the first receiving device may receive the one or more graphics images 150 with a second bandwidth, and the second receiving device may receive the one or more graphics images 150 with a third bandwidth. Preferably, the second bandwidth and the third bandwidth are not higher than the first bandwidth, and the first bandwidth is a multiple of the second bandwidth and/or the third bandwidth. The first bandwidth may be different from the second bandwidth. For example, as shown in FIG. 1A, the receiving mobile phone device 104 may be capable of receiving the one or more graphics images 150 in a bandwidth of 20 frames/second, the receiving PDA device 106 may be capable of receiving the one or more graphics images 150 in a bandwidth of 30 frames/second, and the receiving laptop device 108 may be capable of receiving the one or more graphics images 150 in a bandwidth of 60 frames/second. The transmitting device 102 may be capable of transmitting the one or more graphics images 150 in a bandwidth of 60 frames/second. Thus, the receiving laptop device 108 may receive all the frames transmitted by the transmitting device 102, and the one or more graphics images received by the receiving laptop device 108 has the highest video quality because all frames sent by the transmitting device 102 are received. The receiving mobile phone device 104 and the receiving PDA device 106 may only receive part of the frames transmitted by the transmitting device 102, with the one or more graphics images received by the receiving mobile phone device 104 having the lowest video quality because only a fraction of frames sent by the transmitting device 102 is received.

FIG. 2 is a schematic diagram illustrating a system 200 for sharing one or more graphics images between devices using a screen sharing profile in accordance with an exemplary embodiment of the present invention. The system 200 may include a transmitting device 202 for transmitting one or more graphics images using the screen sharing profile. The one or more graphics images may be stored in or captured by the transmitting device 202. The system 200 may include one or more receiving devices. For example, as shown, the system 200 includes a receiving mobile phone device 204, a receiving PDA device 206, and a receiving laptop device 208. Each of the receiving devices is communicatively coupled to the transmitting device 202 via, for example, wire, wireless communication (e.g., Bluetooth, WiFi), and the like. Each of the receiving devices is suitable for receiving the one or more graphics images with its own bandwidth. As in the calculation of the “lowest common denominator” bandwidth value described above, if a device is capable of receiving a frame-rate that is greater than the lowest common denominator, the device reports its capability nonetheless. The transmitting device may then send additional video frames to reflect the greater bandwidth. For example, the transmitting device 202 may include the contents of a screen 250 in a certain bandwidth, and the screen 250 may have a resolution of 1024×768. The contents of the screen 250 may be transmitted in interlace fashion, wherein some of the interlaced content is receivable by all receiving devices, and some other of the interlaced content is receivable by others, depending on their individual bandwidth capabilities. Bandwidth capability is dependent on a physical display screen resolution of the receiving device, a color depth of the receiving device's display adapter, processing power of the receiving device, memory and other hardware resources of the receiving device. Those skilled in the art would recognize other attributes that affect transmission time of display images in a networked environment. Each of the receiving devices may be capable of receiving the screen 250 in its own bandwidth. The screen sharing profile may be suitable for sharing the screen 250 between the transmitting device 202 and a first receiving device (e.g., receiving mobile phone device 204) and between the transmitting device 202 and a second receiving device (e.g., receiving PDA device 206) by sharing video or image data of the screen 250 and input device actions. Alternatively, the screen sharing profile may be suitable for sharing the screen 250 between the transmitting device 202 and a first receiving device (e.g., receiving mobile phone device 204) at a first bandwidth and between the transmitting device 202 and a second receiving device (e.g., receiving PDA device 206) at a second bandwidth. The first bandwidth may be different from the second bandwidth.

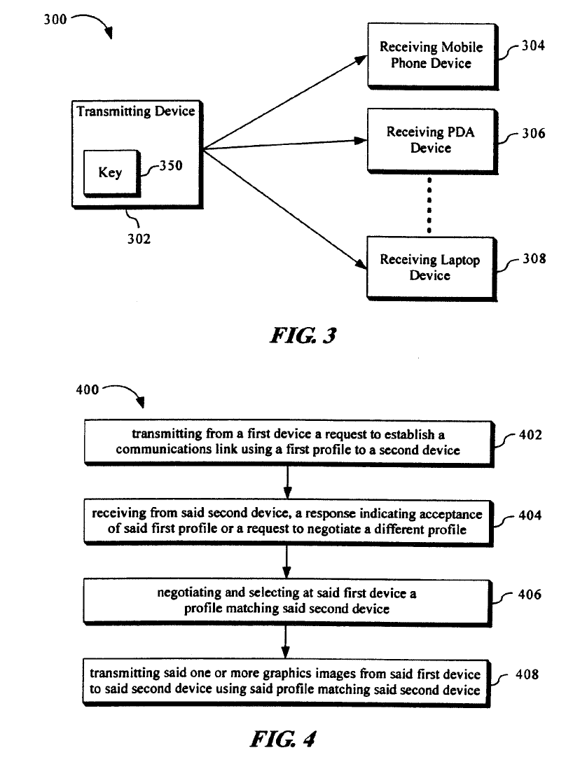

FIG. 3 is a schematic diagram illustrating a system 300 for sharing one or more graphics images between devices using a rights management profile in accordance with an exemplary embodiment of the present invention. The system 300 includes a transmitting device 302 for transmitting one or more graphics images using the rights management profile. The one or more graphics images are captured by the transmitting device 302. The system 300 may include one or more receiving devices. For example, as shown, the system 300 includes receiving mobile phone device 304, receiving PDA device 306, and receiving laptop device 308. Each of the receiving devices is communicatively coupled to the transmitting device 302 via, for example, wire, wireless communication (e.g., Bluetooth, WiFi), and the like. Each of the receiving devices is suitable for receiving the one or more graphics images with its own bandwidth. The rights management profile is suitable for preventing a first receiving device (e.g., the receiving mobile phone device 304) from receiving the one or more graphics images when the first receiving device is not authorized to receive the one or more graphics images. The rights management profile is suitable for encrypting the one or more graphics images with a key and sending the key to the first receiving device (e.g., the receiving mobile phone device 304) when the first receiving device is authorized to receive the one or more graphics images. The rights management profile sends each recipient a unique key (the key is unique to one or a plurality of authorized users). Once each recipient has received the key, the encrypted content can be accessed via that key. Wireless technologies such as Bluetooth or WiFi (wireless ethernet) offer real-time security without incurring the high cost of strong encryption. In Bluetooth, a “pair key” is used to provide security of transmission. In WiFi, a wep encryption key is used for similar purpose. In the present invention, since each user to which the graphics image is being broadcast may have a unique pair key or unique wep encryption key, the present invention simply distributes a graphics image key during the initial discovery of the participants in the distribution of the graphics image. This distribution step may be a point-to-point approach to each participant. In an alternative embodiment, the distribution of this graphics image key may take place off-line, or when the device is set up. The objective is that only the participants in the broadcast of the graphics image session will be able to decipher the encrypted data, all using the same key. The graphics image is encoded with such a key. Once the initial key is set up for each participant, the low bandwidth streaming video profile may change the key dynamically (i.e., dynamic key reassignment) and is used to enhance privacy during a communications session. Once a key has been reassigned, that key remains as the active key for the instant and future sessions.

FIG. 4 is a flowchart of a method 400 for sharing one or more graphics images between devices using profiles in accordance with an exemplary embodiment of the present invention. The method 400 may start with step 402, in which a request to establish a communications link is transmitted from a first device to a second device using a first profile. A response indicating acceptance of the first profile or a request to negotiate a different profile is received from the second device 404. A profile matching the second device is negotiated and selected at the first device 406. One or more graphics images are transmitted from the first device to the second device using the profile matching the second device 408. The profile matching the second device includes at least one of a low bandwidth streaming video profile, a screen sharing profile, or a rights management profile. The second device is communicatively coupled to the first device via, e.g., wire, wireless communication (e.g., Bluetooth), and the like. The low bandwidth streaming video profile is suitable for using a lower common denominator of buffering capacity among the first device and the second device to determine a size of a basic frame (e.g., a whole frame or a partial frame) for the one or more graphics images. Alternatively, using the low bandwidth streaming video profile, the first device is suitable for transmitting the one or more graphics images in a first bandwidth, and the second device is suitable for receiving the one or more graphics images in a second bandwidth. The first bandwidth may be different from the second bandwidth. The screen sharing profile may be suitable for sharing a screen between the first device and the second device by sharing graphics image data of the screen and input device actions. The rights management profile may be suitable for encrypting the one or more graphics images with a key and sending the key to the second device when the second device is authorized to receive the one or more graphics images. Alternatively, the rights management profile may be suitable for preventing the second device from receiving the one or more graphics images when the second device is not authorized to receive the one or more graphics images. It is understood that the one or more graphics images may be captured by the first device, and the first device and the second device may be Bluetooth devices. Those of ordinary skill in the art will appreciate that the method 400 may be applied to a system including three or more devices without departing from the scope and the spirit of the present invention.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for sharing one or more graphics images between devices, comprising:
transmitting from a first device a request to establish a communications link using a first profile to a second device;
receiving from said second device, a response indicating acceptance of said first profile or a request to negotiate a different profile;
negotiating and selecting at said first device a profile matching said second device; and
transmitting said one or more graphics images from said first device to said second device using said profile matching said second device.

2. The method of claim 1, wherein said first device and said second device are network devices.

3. The method of claim 1, wherein said profile matching said second device includes a low bandwidth streaming video profile suitable for using a lower common denominator of buffering capacity between said first device and said second device to determine a size of a basic frame for said one or more graphics images.

4. The method of claim 3, wherein said size is a whole frame or a partial frame.

5. The method of claim 3, wherein, using said low bandwidth streaming video profile, said first device is suitable for transmitting said one or more graphics images in a first bandwidth, and said second device is suitable for receiving frames of said one or more graphics images in a second bandwidth.

6. The method of claim 1, wherein said profile matching said second device includes a screen sharing profile suitable for sharing a screen between said first device and said second device by sharing video or image data of said screen between said first device and said second device.

7. The method of claim 1, wherein said profile matching said second device includes a rights management profile suitable for encrypting said one or more graphics images with a key and sending said key to said second device when said second device is authorized to receive said one or more graphics images.

8. The method of claim 1, wherein said profile matching said second device includes a rights management profile suitable for preventing said second device from receiving said one or more graphics images when said second device is not authorized to receive said one or more graphics images.

9. The method of claim 1, wherein said one or more graphics images is at least one of captured by or stored in said first device.

10. A method for sharing one or more graphics images among devices, comprising:
transmitting from a first device a request to establish a communications link using a first profile to a second device and a third device;
receiving from said second device and said third device, responses indicating acceptance of said first profile or requests to negotiate a different profile;
negotiating and selecting at said first device a profile matching said second device and said third device; and
transmitting said one or more graphics images from said first device to said second device and said third device using said profile matching said second device and said third device.

11. The method of claim 10, wherein said first device, said second device and said third device are network devices.

12. The method of claim 10, wherein said profile matching said second device and said third device includes a low bandwidth streaming video profile suitable for using a lowest common denominator of buffering capacity among said first device, said second device and said third device to determine a size of a basic frame for said one or more graphics images.

13. The method of claim 12, wherein said size is a whole frame or a partial frame.

14. The method of claim 12, wherein, using said low bandwidth streaming video profile, said first device is suitable for transmitting said one or more graphics images in a first bandwidth, said second device is suitable for receiving frames of said one or more graphics images in a second bandwidth, and said third device is suitable for receiving frames of said one or more graphics images in a third bandwidth.

15. The method of claim 14, wherein said second bandwidth and said third bandwidth are not higher than said first bandwidth.

16. The method of claim 15, wherein said first bandwidth is a multiple of said at least one of said second bandwidth or said third bandwidth.

17. The method of claim 15, wherein said second bandwidth is different from said third bandwidth.

18. The method of claim 10, wherein said profile matching said second device and said third device includes a screen sharing profile suitable for sharing a screen between said first device and said second device and between said first device and said third device by sharing video or image data of said screen.

19. The method of claim 10, wherein said profile matching said second device and said third device includes a screen sharing profile suitable for sharing a screen between said first device and said second device at a first bandwidth and between said first device and said third device at a second bandwidth.

20. The method of claim 19, wherein said first bandwidth is different from said second bandwidth.

21. The method of claim 10, where said profile matching said second device and said third device includes a rights management profile suitable for encrypting said one or more graphics images with a key and sending said key to said second device when said second device is authorized to receive said one or more graphics images.

22. The method of claim 10, wherein said profile matching said second device and said third device includes a rights management profile suitable for preventing said second device from receiving said one or more graphics images when said second device is not authorized to receive said one or more graphics images.

23. The method of claim 10, wherein said one or more graphics images is at least one of captured by or stored in said first device.

24. A system for sharing one or more graphics images between devices, comprising:
a first device suitable for transmitting one or more graphics images using profiles; and
a second device communicatively coupled to said first device, said second device being suitable for receiving said one or more graphics images,
wherein said profiles include at least one of a low bandwidth streaming video profile, a screen sharing profile, or a rights management profile.

25. The system of claim 24, wherein said first device and said second device are network devices.

26. The system of claim 24, wherein said low bandwidth streaming video profile is suitable for using a lower common denominator of buffering capacity between said first device and said second device to determine a size of a basic frame for said one or more graphics images.

27. The system of claim 26, wherein said size is a whole frame or a partial frame.

28. The system of claim 24, wherein, using said low bandwidth streaming video profile, said first device is suitable for transmitting said one or more graphics images in a first bandwidth, and said second device is suitable for receiving frames of said one or more graphics images in a second bandwidth.

29. The system of claim 24, wherein said screen sharing profile is suitable for sharing a screen between said first device and said second device by sharing video or image data of said screen between said first device and said second device.

30. The system of claim 24, wherein said rights management profile is suitable for encrypting said one or more graphics images with a key and sending said key to said second device when said second device is authorized to receive said one or more graphics images.

31. The system of claim 24, wherein said rights management profile is suitable for preventing said second device from receiving said one or more graphics images when said second device is not authorized to receive said one or more graphics images.

32. The system of claim 24, wherein said one or more graphics images is at least one of captured by or stored in said first device.

33. A system for sharing one or more graphics images between devices using profiles, comprising:
a first device suitable for transmitting one or more graphics images using profiles;
a second device communicatively coupled to said first device, said second device being suitable for receiving said one or more graphics images; and
a third device communicatively coupled to said first device, said third device being suitable for receiving said one or more graphics images,
wherein said profiles include at least one of a low bandwidth streaming video profile, a screen sharing profile, or a rights management profile.

34. The system of claim 33, wherein said first device, said second device and said third device are network devices.

35. The system of claim 33, wherein said low bandwidth streaming video profile is suitable for using a lowest common denominator of buffering capacity among said first device, said second device and said third device to determine a size of a basic frame for said one or more graphics images.

36. The system of claim 35, wherein said size is a whole frame or a partial frame.

37. The system of claim 33, wherein using said low bandwidth streaming video profile, said first device is suitable for transmitting said one or more graphics images in a first bandwidth, said second device is suitable for receiving frames of said one or more graphics images in a second bandwidth, and said third device is suitable for receiving frames of said one or more graphics images in a third bandwidth.

38. The system of claim 37, wherein said second bandwidth and said third bandwidth are not higher than said first bandwidth.

39. The system of claim 38, wherein said first bandwidth is a multiple of said at least one of said second bandwidth or said third bandwidth.

40. The system of claim 38, wherein said second bandwidth is different from said third bandwidth.

41. The system of claim 33, wherein said screen sharing profile is suitable for sharing a screen between said first device and said second device and between said first device and said third device by sharing video or image data of said screen.

42. The system of claim 33, wherein said screen sharing profile is suitable for sharing a screen between said first device and said second device at a first bandwidth and between said first device and said third device at a second bandwidth.

43. The system of claim 42, wherein said first bandwidth is different from said second bandwidth.

44. The system of claim 33, where said rights management profile is suitable for encrypting said one or more graphics images with a key and sending said key to said second device when said second device is authorized to receive said one or more graphics images.

45. The system of claim 33, wherein said rights management profile is suitable for preventing said second device from receiving said one or more graphics images when said second device is not authorized to receive said one or more graphics images.

46. The system of claim 33, wherein said one or more graphics images is at least one of captured by or stored in said first device.
